(19) United States
(12) Patent Application Publication
(10) Pub. No.: US 2024/0032761 A1
(43) Pub. Date: Feb. 1, 2024

(54) ROBOT AND MAPPING

(71) Applicant: Micropply Limited, Altrincham, Cheshire (GB)

(72) Inventors: Anthony David George Rhoades, Hale, Cheshire (GB); Samuel Paul Cornish-Evans, Knutsford, Cheshire (GB); Jiri Dohnalek, Warrington, Cheshire (GB)

(21) Appl. No.: 18/265,032

(22) PCT Filed: Nov. 23, 2021
(86) PCT No.: PCT/GB2021/053029

§ 371 Date: Jun. 2, 2023

(30) Foreign Application Priority Data
Nov. 24, 2020 (GB) 2018472.7

(51) Int. Cl. A47L 11/40; G05D 1/02; G01N 1/02; G01N 35/00

(52) U.S. Cl. CPC A47L 11/4011; G05D 1/0274; G05D 1/0214; G01N 1/02; G01N 35/00871; A47L 2201/04; A47L 2201/06; G05D 2201/0203; G01N 2001/021; G01N 2001/028

(57) ABSTRACT

A method of monitoring hygiene or cleanliness, the method comprising a robot collecting at least one sample from a location, performing at least one test on the at least one sample to generate at least one data point, wherein said at least one data point is an indicator of hygiene or cleanliness of the location from where the sample was collected and recording the data point in a data file.

The present invention relates to a robot of a type equipped to be involved in monitoring, cleaning and mapping of hygiene or cleanliness levels. The present invention also relates to robots capable of sample collection and cleaning. The present invention also relates to method and process of monitoring, mapping and/or recording of hygiene or cleanliness levels, levels, along with methods of collecting data related to cleanliness and hygiene. The present invention also relates to a method of collecting data related to location hygiene or cleanliness. The present invention also relates to a method of deploying an autonomous robot for the monitoring of hygiene or cleanliness. The present invention also relates to a computer implemented method of generating a mission plan for deployment of an autonomous robot on a route in an area.

In the UK, everyday 1.05 Million National Health Service (NHS) staff risk their health in NHS hospitals/facilities, exposed to microbes/bacteria/viruses. Further, the NHS sees over 1 million patients in 36 hours, and 25M patients a year visit A&E. For patients, long admissions increase chances of HAI (hospital acquired infections). Although staff follow hygiene standards, and there are extensive cleaning and hygiene protocols in place (often using contracted out services), there is no repeatable and systematic autonomous (less deterministic) method to sample, monitor and disinfect the 1,257 NHS hospital sites or the wards holding almost 130,000 beds. Beyond the NHS there are 164,000 hospitals globally.

NHS confederation estimates that 5% of all hospital capacity is affected daily due to infection-based downtime. In a £120 billion business, that is a £6 bn cost impact annually. Hospital acquired infections can lead to expensive settlements and legal expenditure for hospitals. This is all applicable even before the COVID-19 pandemic which began in 2020.

Beyond hospitals and other healthcare environments, recent global healthcare challenges have highlighted the need for hygiene and cleanliness in all buildings and locations, both public and private, and particularly those were a high volume of people may visit frequently (e.g. mass-footfall public spaces, such as schools, shopping centres, public transport facilities and sports venues). Being able to monitor the hygiene or cleanliness of locations may help tackle global healthcare challenges, such as pandemic responses.

There is therefore a need for methods, apparatus and processes of tracking, mapping and monitoring the hygiene or cleanliness of locations, such as public buildings, especially healthcare facilities. Particularly in healthcare facilities this will allow safeguarding of patients, visitors, professional staff, and health practitioners.

According to a first aspect of the present invention, there is provided a method of monitoring hygiene or cleanliness, the method comprising a robot collecting at least one sample from a location. The method involves performing at least one test on the at least one sample to generate at least one data point, wherein said at least one data point is an indicator of hygiene or cleanliness of the location from where the sample was collected, and recording the data point in a data file. Preferably the robot is autonomous.

Autonomous Robots may be completely autonomous (i.e. free from human operation and/or supervision) or may require at least partial human operation and/or supervision depending on the application. The partial human operation and/or supervision may be limited to the initial deployment of the robot.

This method provides major advantages to those in charge of locations where cleanliness or hygiene monitoring would be desirable, such as hospitals, granting an eloquent and effective method of monitoring hygiene or cleanliness not envisioned before. Resultant data can be used to measure and monitoring hygiene or cleanliness of locations. The data/results can then provide targeted disinfection as well as standardised routine and/or daily swab-based hygiene inspections to improve overall hygiene and cleanliness of locations. The data is also a powerful tool in future tracking and monitoring of hygiene or cleanliness, with possible targeted cleaning or building design, as described in detail herein. Results can be aggregated to provide a measure for risk stratification and other wide-area cleanliness or hygiene analysis across multi-building complexes, or even across sites on a national or international scale. Because this system can be autonomous and is digital, data can be generated, tracked and uploaded in real-time.

Machines, rather than people, can carry out complex and less deterministic decisions about what, where, when, how, and how often to collect samples from test locations. Robots can be equipped with a suite of artificial intelligence (AI) and machine learning algorithms for optimisation of any of the described processes described herein whilst adapting in real-time to environmental factors, known constraints and/or feedback. AI-based sampling is applicable to all the sampling/swabbing methods described herein. Robots described herein may also have AI capability to ‘hand-off’ of samples to local testing units or facilities, through automated processes. AI and machine learning work together to enable robots to remember/recognise areas where problems typically occur (from historical sampling data based on heat map hot spots) and, based on algorithms, suggest adjustments to future mission plans (for sampling or disinfecting) to increasing targeting in those areas and then to revert when these areas become ‘under control’.

Using a robot to carry out this process is human labour saving, which saves costs and can reduce human exposure to possible negative effects from having to take samples (i.e. acquiring infections) or cleaning locations thought to need cleaning. Sample collection by robots is more repeatable, reducing variation in collected data and improving accuracy of data. It also gives the ability to truly randomise testing locations whilst recording the precise location of each swab test. The herein described methods and robots improve safeguarding of locations, such as public buildings. Carrying out the methods described herein will also have a positive economic impact, due to saved money on cleaning, reducing building down time during cleaning and reducing pay-outs of settlements and legal fees from infections, thus financial and legal risks can also be minimised.

The advantages in healthcare settings, such as hospitals, are particularly noteworthy. The methods and robots described herein will benefits patients (and their care/outcome/wellbeing during hospital stays or visits to healthcare facilities), visitors, professional staff, and health practitioners, limiting exposure and risks associated with sub-optimal hygiene/such as from known or new-virus-threats. The methods and robots described herein could aid in extending patient life, reducing legal and financial risks for healthcare providers, and maximising safe ‘up-time’ of healthcare facilities.

There will also be a reduction in building downtime when cleaning needs to take place, as the herein described methods and robots allow for improved and more targeted monitoring hygiene and cleanliness of buildings. Less time will need to be taken to shutting areas or whole locations/buildings, especially when an infection or outbreak is discovered.

Preferably, the method comprises the robot collecting multiple samples from multiple locations and also the method comprises performing the at least one test on each sample collected to generate multiple data points as multiple indicators of hygiene or cleanliness of the multiple locations from which samples were collected. Multiple samples being collected allows a multiple location or an area-wide picture or assessment of hygiene or cleanliness to be made.

Preferably, the method comprises storing the sample or samples on board and then transporting the sample or samples to a testing station, facility or location or means for the samples to be removed from the robot and testing be carried out at said location externally to the robot. This allows powerful laboratory testing to be carried out on samples, to generate the data needed to assess the hygiene or cleanliness of a location or locations.

Preferably, the method comprises performing at least one test on the at least one sample on-board the robot. Carrying out the testing on-board allows for real time production of data, with all the benefits described herein, and also reduces the need for laboratory-based testing.

Preferably, when the test is to be carried out onboard the robot, the robot carries out the at least one test immediately, or wherein the robot stores the sample or samples on-board the robot and carries out the at least one test or tests at a time later than the sample was collected. The samples could be collected in batches and tested in batches.

Preferably, the robot moves autonomously between locations on a pre-determined route, path or map. This could be called a mission plan.

Preferably, the location of the sample location is also recorded by the robot and added to the data file, and/or wherein the time the sample was collected is also recorded by the robot and added to the data file. This is so each test result is linked to the location of the sample and/or the time the sample was collected in the data file. This allows for powerful data to be collected and generated, for the analysis, mapping etc described herein.

Preferably, the location of samples is known from the pre-determined route, path or map. This would not necessarily require recording of the sample collection location in real time, as the location is already known from the route, path or map.

Preferably, the method further comprises generating a heat map of data points using the location data in combination with the other data collected by the robot, including the data related to hygiene or cleanliness. Preferably, the heat map of data points is an indicator of wider-area cleanliness or hygiene of a building, facility or single site, or indicates areas of a wider area which may need cleaning. Wider-area can refers to a large area, for example a wider area than samples collected by a single robot in single pass, or multiple passes, or it could refer to more than one area, floor, building or to a wider area such as a whole country, trust, or a world map.

Data points, e.g. swab testing results, can be uploaded to the cloud and results fed back to local management via a user management platform. Data can be automatically aggregated and use that to create a heat map per location or building, based on results. For example, pre- and post-cleaning results can be monitored and use aggregate data to create a national/international heatmap across all buildings. The applications and advantages of this are described herein.

The methods and robots described herein are combined with artificial intelligence, machine learning, and an end-to-end Cloud SAAS (Software As A Service) platform that work together to create, for example, hygiene maps/plans with a high level of accuracy underpinned with an advanced user-interface.

Preferably, prior to the robot collecting at least one sample from a the robot carries out an inspection of the location to have a sample collected from to determine if it should sample the location or not, optionally wherein the inspection comprises taking a photograph or measuring a level of a contaminant at the location prior to collecting the sample. This allows a robot to determine if sample collection is necessary. For example, a photograph of a location could be taken, dirt level analysed and the robot decide not to sample or clean the area based on the analysis.

Preferably the method further comprises, after sample collection and testing, cleaning the location from where the sample was collected, if the test result indicated that the level of hygiene or cleanliness of the sample was below a predetermined threshold value of cleanliness or hygiene. Preferably, the same robot cleans the location from where the sample was collected; or preferably, the robot sends an indicator, alert or a signal to another robot or to a person to carry out the cleaning. Preferably, the robot cleans the location by one or more of the following: spraying or releasing a disinfectant or other cleaning material, using a UV or UV-C lamp, scrubbing, wiping or otherwise mechanically agitating the location, or vacuuming the location.

Preferably, the location or locations from which samples are collected are predetermined locations on a route, path or map to be followed by the robot, or wherein the location or locations from which samples are collected are a random or not pre-determined location or series of locations within a wider known set area. This can be known as the robot's “mission plan”.

Throughout the collection process as a whole, the robot could collect a mixture of samples, some from predetermined locations along a pre-determined route, path or map and some from random locations also long that pre-determined route, path or map, or deviating from the pre-determined route, path or map.

Preferably, the robot is capable of recording other data, such as recording human footfall around the robot as it operates, and recording such data as part of the data file. Other data that can be collected by the robots include light levels (for example with a lux meter, light detector), air quality (for example level of oxygen or CO2, level of pollutant or particulates in the air, tests could be carried out onboard the robot, could be used in conjunction with air-virology testing), moisture levels (for example measuring dry air or damp), wetness or dryness of testing surfaces (for example to test floor safety), number of people or other objects around the robot (for example footfall, how often the robot had to move around people through smart sensors), or any other parameter which could be linked to a building or facilities safety, environmental condition or quality.

Preferably, the sample is a swab. The sample could be defined as a sample collection means, and then the sample is that which the sample collection means actually collects.

Preferably, the location is selected from the following: a floor, a wall, a roof, a bed, a door, a handle, a toilet, a sink, a bathroom, a shower, a bath, a medical item, bin, waste disposal unit, or a support such as a leg of one or more of these named locations, shoes, clothes or possessions of a patient, or a patient.

Preferably, the data point which is an indicator of hygiene or cleanliness is a data point collected to give an indication of one or more of the following: level of dirt or debris, level of disease, level of virus, level of bacteria, level of microorganism, level of fungi, level of pathogen, biological material deposited, biological material present, level of waste, level of contaminants or level of sterility, air quality. “Indicator of hygiene or cleanliness” refers to something which can be collected, measured or tested e.g. one or more of the things which can be collected, measured or tested described herein. The methods and robots as described herein could be understood to just be collecting samples/data to give a direct indication of one or more of the following: level of dirt or debris, level of disease, level of virus, level of bacteria, level of microorganism, level of fungi, level of pathogen, biological material deposited, biological material present, level of waste, level of contaminants or level of sterility, air quality.

Preferably, in the method more than one robot is collecting samples from more than one location at any one time.

Preferably, the location is a location within a medical facility, hospital, doctors surgery, clinic, field hospital, dentist, mobile medical unit or facility, testing facility, blood donation facility, a care home or a nursing or other such palliative-type care home, rehabilitation facility, outpatient clinic, diagnostic laboratory, ambulance, medical vehicle, non-medical facility within a medical facility such as a coffee shop, or other such medical related building.

According to a second aspect of the present invention, there is provided an autonomous robot comprising means to collect a sample from a location; means to test the sample for an indicator of hygiene or cleanliness of the location from where said sample was collected and/or means to clean a testing location; and means to navigate the robot. The means to navigate the robot will be capable of navigating the robot to another testing location, or along a route or to carry out a mission plan (as described herein), or back to a home or base location (e.g. a charging point).

Preferably, the robot also comprises means to record the location the sample was collected from. The robot may also comprise means to carry out any of the functions of the robots described herein with relation to the other aspects of the invention, e.g. the herein described methods.

Preferably, the robot further comprises means to clean a testing location, as described herein. Preferably, the robot further comprises means to inspect a location prior to sample collection, as described herein. Preferably the robot comprises means to control the robot functions. Preferably, the robot comprises sample storage means, as described herein. Preferably, the robot comprises means to facilitate collection of a sample, for example a robotic arm. Preferably, the robot comprises wireless communication means, as described here.

According to a third aspect of the present invention, there is provided a method of collecting data related to location hygiene or cleanliness, the method comprising using at least one robot to collect data related to location hygiene or cleanliness. Preferably, the robot collects samples for analysis from at least one location and wherein at least one test is carried out on the sample in order to generate at least one data point, wherein said at least one data point is an indicator of hygiene or cleanliness of the location from where the sample was collected.

Preferably, the method comprises subsequently analysing the collected data in order to present the data in the form of a heat map.

Preferably, the data provides an indicator of cleanliness or hygiene of an individual locations and also on a site/organisation/company/regional/country/world-wide scale of multiple locations. This data can then be presented in a heat map showing levels of hygiene or cleanliness of locations on a map. Preferably, further data related to the cleanliness or hygiene of location such as footfall or time can also be collected by the at least one robot. Data points can be linked together, such as time and cleanliness or hygiene, or measured footfall and cleanliness or hygiene could provide powerful tools to those who need to manage locations, both on an individual location and on a site/organisation/company/regional/country/world-wide scale. Heat maps can be generated which layer the different data collected in layers, showing different data on the same map, possibly switchable between the different datas. Data sets could be shown together on the same heat map.

Embodiments of the invention will now be described by way of example only and with reference to the accompanying drawings, in which:

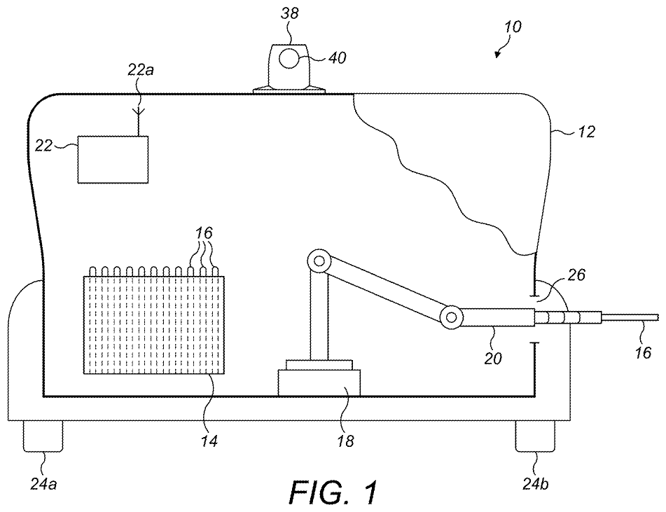

FIG. 1 is a schematic diagram of an exemplary robot of the present invention;

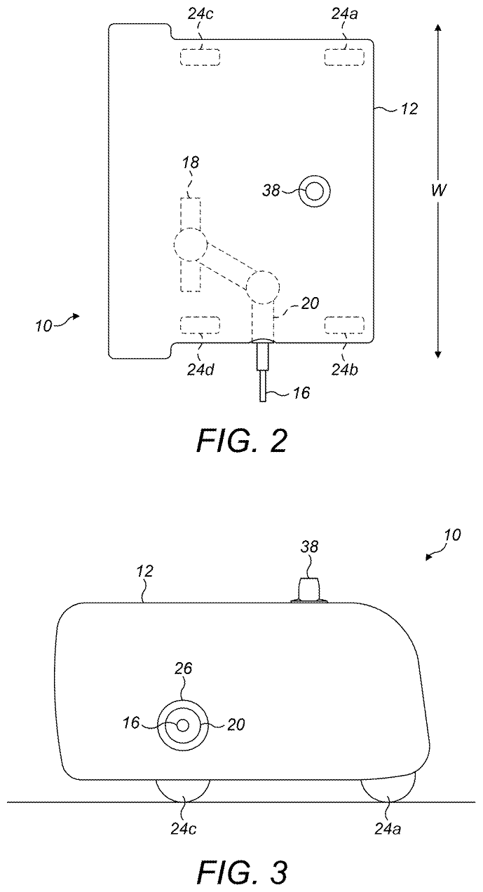

FIG. 2 is a plan view of an exemplary robot of the present invention;

FIG. 3 is a side elevation of an exemplary robot of the present invention;

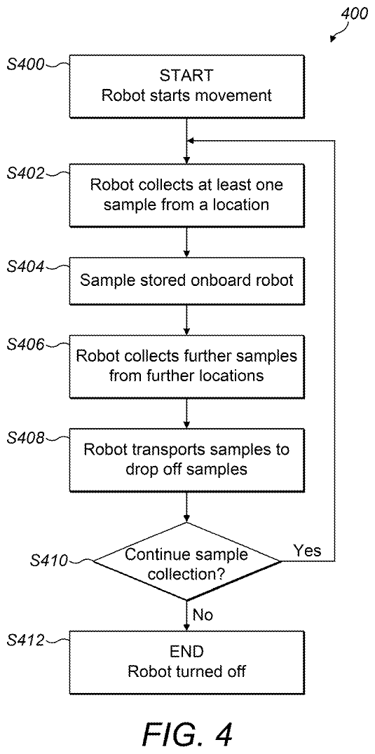

FIG. 4 is a flow diagram showing an exemplary method of the present invention

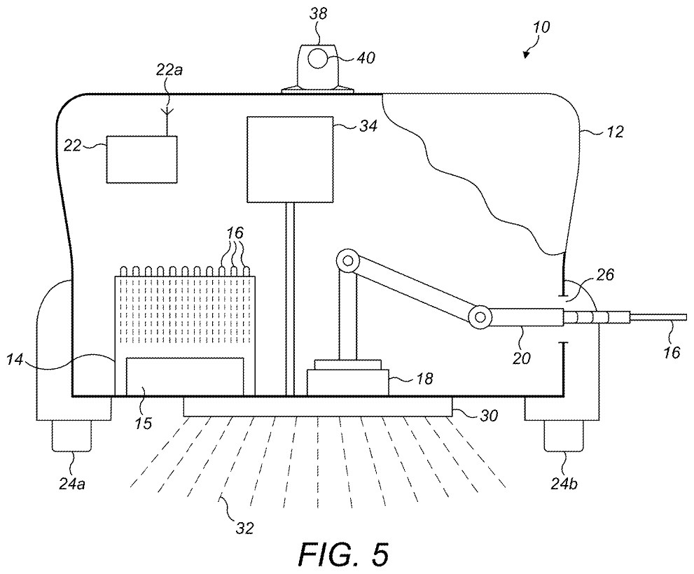

FIG. 5 is a schematic diagram of another exemplary robot of the present invention;

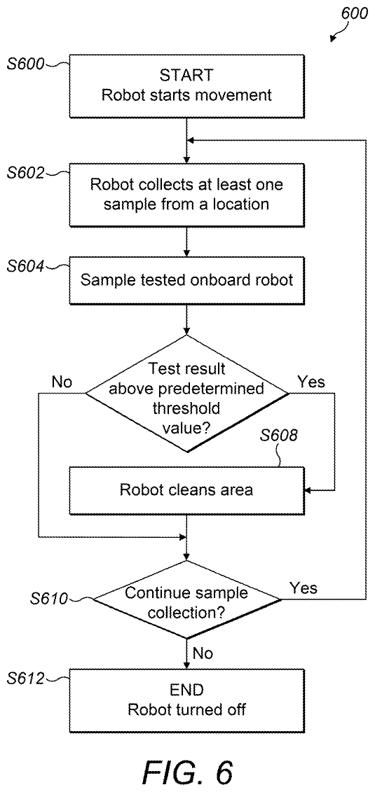

FIG. 6 is a flow diagram showing another exemplary method of the present invention

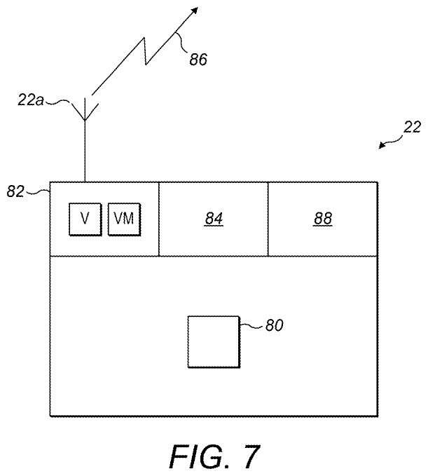

FIG. 7 is a schematic diagram of a smart communications module as could be used in a robot of the present invention;

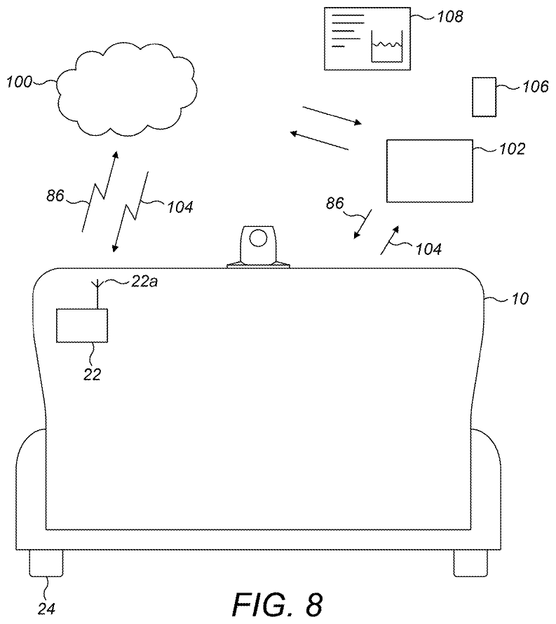

FIG. 8 is a schematic diagram of an exemplary secure communications network between an exemplary robot of the present invention robot, the edge, the cloud and a data processing device;

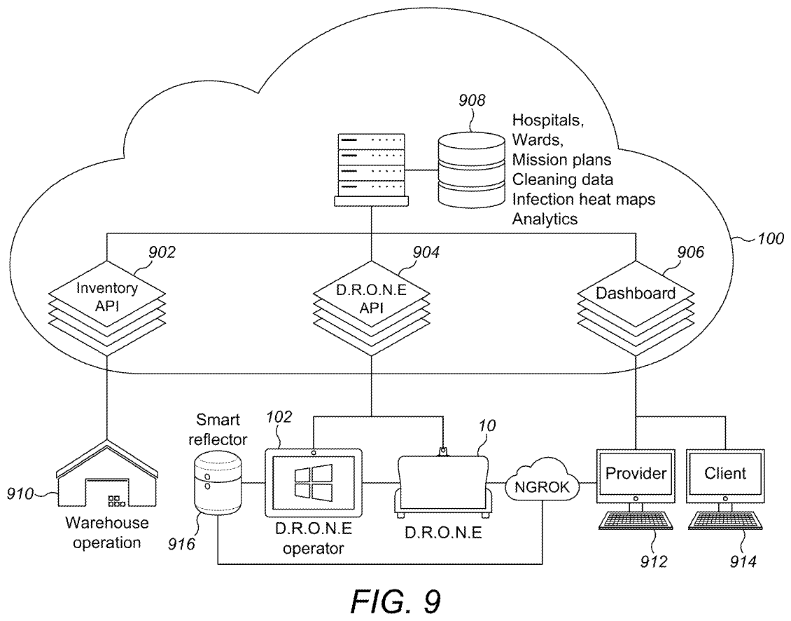

FIG. 9 is an exemplary system setup;

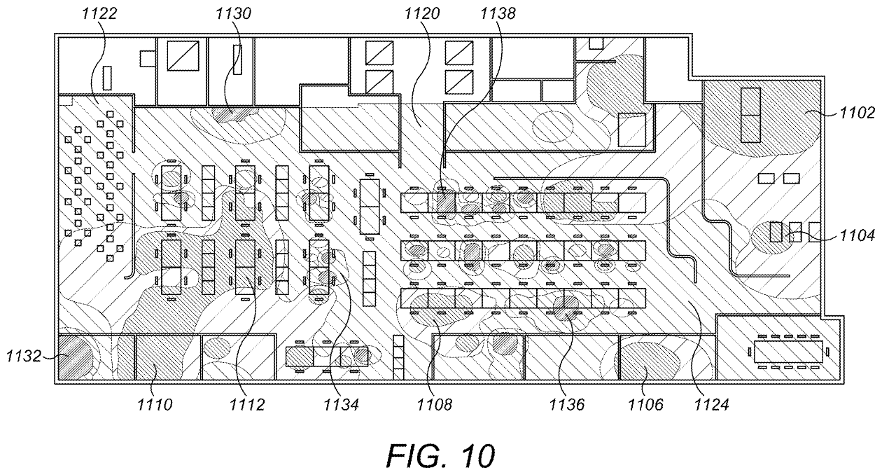

FIG. 10 is an example heat map that could be produced by the presently claimed methods, processes, systems and robots described here; and

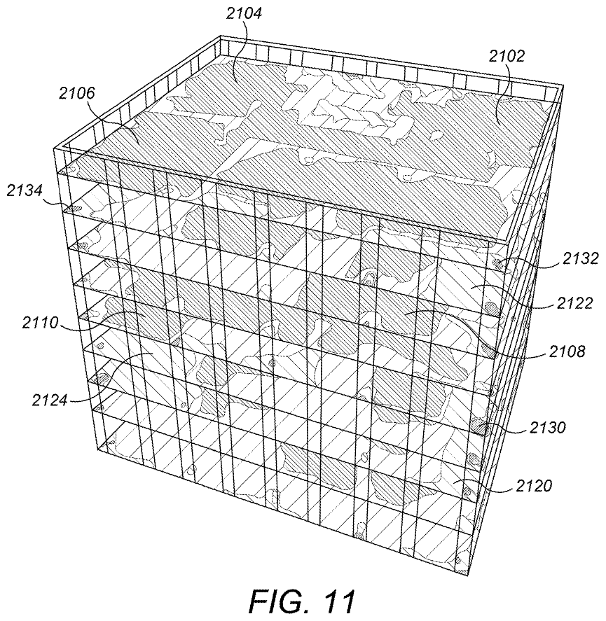

FIG. 11 is another example heat map that could be produced by the presently claimed methods, processes, systems and robots described here;

The present techniques will be described more fully hereinafter with reference to the accompanying drawings. Like numbers refer to like elements throughout. Parts of robots are not necessarily to scale and may just be representative of components of robots or other described entities.

All of the robots described herein are intended for use with off the all methods, processes and systems described herein, and vice versa. Exemplary embodiments described below are only exemplary and do not prevent combinations of features from different below described robots, methods, systems or other aspects or embodiments.

FIG. 1 is a schematic diagram of an exemplary robot of the present invention. Referring to FIG. 1, shown is a schematic diagram of a robot 10 which is capable of collecting and storing samples. Here swabs 16 are shown as the sample collection means. The robot 10 has an outer case 12 cut away to reveal a sample storage unit 14 and a means to facilitate samples collection. The means to facilitate sample collection here is a moveable robotic arm 20 attached to a base 18. The arm shown is a partially telescopic arm and is shown holding a swab 16. The arm is show as reaching through a hole 26 in the case 12.

In operation, the robotic arm 20 can collect samples, such as with swabs 16, and store them in the sample storage unit 14. The robotic arm 20 could collect samples in a number of different ways, for example by swabbing, scraping, wiping, capturing air or gas, sucking in air or gas, sucking in dirt or debris, adding a liquid and then collecting the liquid, or with abrasion. Sample collection techniques can be tailored to the type of sample which is to be collected and any such collection techniques known in the art could be used.

The robotic arm 20 is shown as robotic arm which can move in multiple angles/degrees of freedom, able to collect samples from wherever needed around the robot. The arm 20 can be a multi-axis robotic arm capable of articulation. A means to facilitate sample collection could collect a sample from above, below or anywhere around a robot. However, other appropriate types of robotic arms or other appropriate sample collection techniques known to those skilled in the art could be incorporated into the robot. For example, a vacuum could collect gas or air samples for air-virology testing, a brush could collect dirt or debris, or swabs could collect samples from patients. These could be as part of a robotic arm, or any other means known in the art to facilitate mobile sample collection. The arm 20 can be stored inside the robot 10 casing 12 when the robot 10 is moving in order to avoid knocking things when the robot 10 moves, or unbalancing the robot 10.

Multiple samples (here swabs 16) are shown in the sample storage unit 14. The sample storage unit 14 will be whatever unit is suitable for storage of the type of samples to be collected by the robot. If the robot is configured to collect multiple sample types, the sample storage unit can be configured to store multiple different sample types. Robots could have multiple different sample storage units, just one is shown in FIG. 1 to represent all possible onboard sample storage. Different sample storage units could store different sample types. If swabs or other individual sample collection or storage means such a tubes are to be used then the empty or not yet used collection or storage means can also be stored in the sample storage unit 14, as well as those which have been used to collect a sample. The robotic arm/robot onboard control system will be programmed (e.g. part of a fulfilment system) to know which samples/sample collection means have been used and which have not. They could be marked when used to facilitate this. Any suitable marking means known in the art could be used. Samples/sample collection means could be marked with the data related to the sample, e.g. location or time data. A mark could for example be a QR code which contains this data.

Sample collection means could be swabs, tubes, wipes, or whatever means known in the art to collect the desired samples. Samples to be collected could include dirt, debris, mud, soil, waste, excrement, discharge, tissue from a patient, DNA, RNA or other nucleic acid form, spit, blood or other bodily fluid, air or gas.

Samples can be collected from the desired location or locations, for example from a floor, a wall, a roof, a bed, a door, a handle, a toilet, a sink, a bathroom, a shower, a bath, a medical item, bin, waste disposal unit, or a support such as a leg of one or more of these named locations, shoes, clothes or possessions of a patient. A sample can be collected from a patient, which may require a greater degree of precision than from a wall, but is also described herein. A sample could be collected from a specific part of a patient, with or without the patient knowing, i.e. a swab could be run along the arm of a sleeping or unconscious patient, or a swab could be collected by a compliant patient from the nostril(s) of a patient. The robot may be programmed to a level to be able to interact with a patient to collect the desired sample. The robot may be able to interact with a patient to ask them to comply or submit to sample collection.

A sample could be whatever is collected when a sample collection means such as a swab is agitated against or on the location the sample is to be collected from. Multiple different types of the above listed samples could be collected in a single collection when a swab is agitated against e.g. a floor, patient or wall. Preferably, the sample collected is a physical sample.

As used herein, ‘patient’ refers to be an individual in a hospital or medical facility. Whilst they may be ill or requirement treatment, when used herein ‘patient’ could encompass anybody located within a medical building or facility, so samples could also be taken from staff or visitors for purposes of monitoring hygiene or cleanliness.

Said location or locations could be within a medical facility, hospital, doctors, clinic, field hospital, dentist, mobile medical unit or facility, testing facility, blood donation facility, a care home or a nursing or other such palliative-type care home, rehabilitation facility, outpatient clinic, diagnostic laboratory, ambulance, medical vehicle, non-medical facility within a medical facility such as a coffee shop, or other such medical related building. Or, they could be in other buildings where monitoring cleanliness or hygiene would be desired, such as a school, a mall or a shopping centre, a public transport facilities such as a train or bus station, a library, a police station, a place of work such as an office, a hotel, a leisure facility such as a gym or a swimming pool. ‘Patient’ in such a scenario would not necessarily apply to an ill person, but to anybody in such a facility a sample was collected from.

In operation the robot of FIG. 1 stores the sample or samples e.g. swabs 16 on board in the sample storage unit 14 and then transports the sample or samples to a testing station, location, unit or facility external to the robot for the sample or samples to be removed and the sample(s) tested. When this occurs, the whole sample storage unit 14 could be removed, or the sample or samples themselves removed individually or in batches from the unit. When removed a new empty sample storage unit 14 could be put in the robot for the next use, or just the used sample collection means (which could be all of the sample collection means) can be replaced or topped up.

The robot has a smart communications module 22 described more fully in FIG. 7, which may also serve as or be connected to an on-board robot control system (not shown in FIG. 1). All robots described herein will have some form of on-board control system, and these are well known in the art. The smart communications module 22 comprises a transceiver 22a for communication with remote resources (not shown in FIG. 1).

The robot 10 comprises wheels 24 for movement, a position sensor 38 and laser 40. Position sensor 38 may comprises a Global Positioning Device for navigation (e.g. through GPS) or the robot may use triangulation with known positioning reflectors and the laser 40 for positioning. The position sensor may be located wherever appropriate on or in the robot for whatever positioning means is to be utilised by the robot. In operation, the robot may be in constant communication with a positioning device or means and may reposition itself based on communication from a Global Positioning Device. Reflectors and smart Reflectors may be used as part of the positioning and robot movement system, as described in other applications by the Applicant.

Robots may have programmed routes, maps or pathing as described herein, or they may move in a random but smart way through locations or facilities. Robot programmed routes, maps or pathing may be described as “mission plans” herein.

The robots described herein may also have smart robot functionality, such as through smart sensors and chips installed, which enable the robot to react to the surroundings. For example, sensors to detect objects around the robot so that the robot can avoid such objects. Whilst robot mapping and routes can be programmed with known objects in mind, objects can move and it would be preferable to have the robot able to react to such changes in the terrain or objects in the planned pathing of the robot. This may also be beneficial when a robot has been instructed to collect random samples from a series of locations, with or without mapping. When operating in facilities where there are people, e.g. hospitals, it would also be beneficial for robots to be able to account for people and avoid them. Robots may also comprise alarms or other such alerts to alert people and/or users of their presence or people or other such object's proximity to the robot. Robots can be programmed to operate when people are not around. Robots may also be programmed to use sensors to detect motion and shut down completely, or shut down specific functions such as turning UV lights off if a person enters a predefined area around the robot.

Robots can rely on simultaneous localization and mapping (SLAM) to navigate and can then operate completely on its own. Robots can travel from charging stations, through hallways, up and down elevators, using lifts if necessary, and perform sample collection, cleaning and other functions without human intervention before returning to recharge.

Robots may need to be fitted with access communication means, to communicate access needs when access required into closed or locked areas.

The ground wheel arrangement 24 comprises wheels (24a and 24b shown in FIG. 1) to steer the robot 10 along a path to affect the sampling or other operations. This may be under the control of a file that can be loaded into the on-board control system such as may be contained communications module 22.

The wheel arrangement 24 may have independent drives to manage torque for optimised positioning accuracy on any surface. The independent drives may be connected to the smart communications module 22 in order to feedback into drive control. The robot 10 may be able to respond in real time to changing terrain needs. The robot 10 may include an autonomous traction management capability, to safeguard the terrain the robot is interacting with.

The robots, systems, and methods described herein can be adapted for use with different types of surface of substrate, depending on the purpose and surface for it to be used with. The robots, systems, and methods described herein can be used to be able to traverse and/or clean multiple different substrates, surfaces, or the ground. For example, these could be wooden floors, lino floors, stone floors, hospital or medical facility floors, tiling, swimming pool surrounds or formation materials, grass, turf, AstroTurf, artificial turf, synthetic turf, plastic turf, concrete, polished concrete, tarmac or tarmacadem ground surfaces, dirt, gravel, wood chip, carpeting, rubber, roads, asphalt, brick, sand, beaches, mud, clay, wood, decking, tiling, stone, rock and rock formations of varying types of rock or stone, snow, ice, ice rinks, artificial snow, polymer surfaces such as polyurethane, plastic, glass and leather.

The robot in FIG. 1 is shown with wheels, but the robot could be provided with any suitable locomotion means, especially those suitable for the intended terrain. The locomotion means could be wheels, tracks, legs (e.g. bipedal humanoid like robot or a millipede like robot), or it could be a rolling type robot.

FIG. 2 is a plan view of an exemplary robot of the present invention; robot 10 has casing 12, wheels 24a, 24b, 24c and 24d and position sensor 38. Robotic arm 20 is also show, holding a swab 16 and attached to arm base 18.

FIG. 3 is a side elevation of an exemplary robot of the present invention; robot 10 has casing 12, wheels 24a and 24c and position sensor 38. Also shown is hole 26 in casing 12, with robotic arm 20 and swab 16 showing face on as if it was sticking straight out of the robot.

FIG. 4 is a flow diagram 400 showing an exemplary method of the present invention. The steps of the method described herein could be applied to all methods described herein. It starts at step S400, with the robot being turned on or starting, starting movement. This robot can then autonomously move between locations on a pre-determined route, path, mission plan or map, or it could be controlled by a controller or central control unit. The robot could move randomly between two different points, i.e. a start and an end point, or from a home base point and back to this home base point.

In step S402 the robot collects at least one sample from a location. Sample collection can be by means as described above. The location could be a predetermined location on a route, path or map to be followed by the autonomous robot, or the location could be a random or not pre-determined location collected, either from the location on a route, path or map to be followed by the autonomous robot, from a random location when the robot is moving randomly. Alternatively, the robot could be directed to a location to collect a sample by a user, for example through an external robot control unit.

Once the sample is collected, the sample is then stored onboard the robot, as noted in step S404. Multiple samples could be collected from a single location, or just a single sample collected from a single location. Multiple samples of the same type could be collected from a single location, and/or multiple different type samples could be collected from a single location.

As depicted in FIG. 4, the robot can then go on to collect further samples, step 406, before moving onto step 408. Alternatively, the robot could move straight onto step 408 without collecting further samples, step 406 is optional and just a single sample could be collected. The further locations could be a series of locations within a wider known set area.

Throughout the collection process as a whole, the robot could collect a mixture of samples, some from predetermined locations along a pre-determined route, path or map and some from random locations also long that pre-determined route, path or map, or deviating from the pre-determined route, path or map. Robots could be programmed to collect multiple samples from multiple points.

In step 408 the robot transports the sample(s) to drop off the sample(s). This can be when sufficient samples are collected, or the sample collection path route or map is complete, or when the sample storage unit onboard the robot is full. Or this could be when the user controlling the robot indicates sufficient samples or those sample(s) they were looking to collect have been collected.

The robot could drop the sample(s) off at testing station, facility or location or means for the samples to be removed from the robot and testing to be carried out at a location externally to the robot. This could be a laboratory or testing facility in the same building as the robot, or this could be to pass the sample(s) onto means which can then in turn facilitate the transport of the sample(s) to a testing facility. This could all be without human intervention, or humans could be involved in handling of the samples (without contamination), i.e. humans removing them from the robot and transporting them to the testing facility. The testing facility could be external to the building the robot is in.

After this, at decision point S410 a decision must be made if the robot is to continue collecting samples, or if the operation is completed. If ‘no’, do not continue sample collection, then step S412—end—robot is turned off is carried out. This could be back at the same point as where the robot starts, which could be the same point as sample drop off, or it could travel to a storage or charging facility. This could be the same as the sample drop off point, i.e. starting or turning on, charging, maintenance, sample drop off, and turning off or ending of the robot could all be in the same place, i.e. a robot operations warehouse or facility. Alternatively, the decision could be ‘yes’, continue sample collection, then the process reverts back to S402 and the robot moves on to collect at least one sample from a location and the process repeats itself.

How the S410 ‘yes’ or ‘no’ decision is come to could be automated, depending on time of day, number of samples collected or number of locations samples have been collected from; it could be based on a pre-determined schedule or sample collection plan; or it could be based on a pre-determined route, path, mission plan or map for the robot to be taking and whether more samples needed to be taken to complete that pre-determined route, path, mission plan or map; or it could be based on user input and not automated.

FIG. 5 is a schematic diagram of another exemplary robot of the present invention. The robot of FIG. 5 is much like the robot of FIG. 1, but with additional features depicted. Referring to FIG. 5, shown is a schematic diagram of a robot 10 which is capable of collecting and storing samples. Here swabs 16 are shown as the sample collection means. The robot 10 has an outer case 12 cut away to reveal a sample storage unit 14 and a means to collect samples. The means to facilitate collection of samples is shown as a moveable arm or a robotic arm 20 attached to a base 18. The arm shown is partially a telescopic arm and is shown holding a swab 16. The arm is show as reaching through a hole 26 in the case 12. Additionally, over the robot of FIG. 1, shown is a sample testing unit 15, a cleaning unit 30 and a cleaning fluid or disinfectant supply unit 34.

The robot of FIG. 5 is capable of onboard sample testing in the sample testing unit 15. Here, the sample testing unit 15 is shown as part of the sample storage unit 14, however it could be separate from the unit. In the unit, samples can be tested for whatever parameters are of interest, i.e. the original purpose for the sample to be collected.

Testing of samples could be carried out onboard the robot, or at a testing facility external to the robot. Here, the testing unit is shown onboard the robot. Testing the sample(s) is to determine a result that will give an indicator of the level of hygiene or cleanliness of the location tested (and in turn possibly of a wider location as a whole). When carried out on board, the data generated or any testing which involves computational analysis may be carried out onboard, or may be in communication with external computer systems as described below in other Figures. Analysis could be carried out onboard or externally.

Level or indicator or amount of hygiene or cleanliness as used herein may refer to level of dirt or debris, level of disease, level of virus, level of bacteria, level of microorganism, level of fungi, level of pathogen, biological material deposited, biological material present, level of waste, level of contaminants or level of sterility, air quality, or any other indicator of hygiene or cleanliness known in the art.

Specific indicators e.g. bacteria, pathogens, fungi, microorganisms or viruses could be tested for, for example those known to be prevalent or already found or known to be present in the location to be tested. Or those which are common to the type of building to be tested could be tested for. Alternatively, or additionally overall levels of indicators e.g. bacteria, pathogens, fungi, microorganisms or viruses could be tested for. This could be based on historical data collection from the location(s) and which the robot has analysed or external analysis has been carried out upon. The robot's machine leaning capabilities may feed into this process.

Particularly, when testing in healthcare or medical facilities, it may be beneficial to test for pathogens that cause Healthcare-Associated infections (HAIs), also known as a nosocomial infection or hospital acquired infections. These are infections that are acquired in a hospital or other health care facility. As used herein, pathogen refers to a bacterium, virus, parasite, prion, or other such microorganism that can cause disease. Bacteria that could be of particular interest to test for in a hospital or medical environment include Staphylococcus aureus, Methicillin-resistant Staphylococcus aureus, Pseudomonas aeruginosa, Acinetobacter baumannii, Stenotrophomonas maltophilia, Clostridioides difficile, Escherichia coli, Mycobacterium tuberculosis (Tuberculosis), Vancomycin-resistant Enterococcus, Streptococcus pyogenes and Legionella bacteria. Viruses that could be of particular interest to test for in a hospital or medical environment include pneumonia causing viruses, influenza, respiratory syncytial virus and, cytomegalovirus, cold viruses, coronaviruses and Gastroenteritis causing viruses. Fungi that could be of particular interest to test for in a hospital or medical environment include Candida albicans, Candida auris and Aspergillus fungi.

Testing of samples could be as simple as measuring the level of dirt in a sample, or it could be more complicated, such as carrying out a test which would indicate the presence of a virus of a bacterium sample. Testing means are standard in the art and can be carried out on small samples in small, portable, testing units (i.e. onboard the robot if necessary), or in large-scale laboratory facilities.

For example, to test for bacteria the testing could be gram staining and inspection of samples. Coagulase tests or Catalase tests can also indicate presence of bacteria. Polymerase chain reaction (PCR) testing, which involves isolating and amplifying lengths of DNA, RNA or other such nucleic acid chains from samples containing pathogens such as bacteria or viruses and then comparing to known levels in samples or lengths from known samples, can be used to test for microorganisms such as bacteria or DNA. Enzyme-linked immunosorbent assay (ELISA) testing can test for specific organisms, such as by detecting bacterial antigen during an infection or antibacterial antibodies. Samples may need to be suitably prepared before testing, for example bacteria could be cultured before testing.

Particularly, onboard testing could involve PCR testing of samples, such as using a multiplex PCR system that integrates sample preparation, amplification, detection and analysis. Samples can be tested for bacteria, viruses, yeast or parasites using comprehensive panels that offer testing for sets of pathogens associated with some of today's most pressing healthcare challenges.

A result that will give an indicator of the level of hygiene or cleanliness of the location tested could be a ‘yes or no’ type result, for example ‘yes’ bacteria is present, or ‘no’ bacteria is not present. Alternatively, it could be that an amount of something, such as bacteria of a particular type, or dirt, is above a predetermined threshold level. This pre-determined threshold level could be a level set at where a certain amount of something is deemed safe. In some cases the microorganism originates from the patient's own skin microbiota can become opportunistic after surgery or other procedures that compromise the protective skin barrier and infect a patient. Thus, levels of bacteria may be safe to be present, so the level could be set above that safe level. Levels could have pre-set indications e.g. really dirty, moderately dirty, mildly dirty, clean.

When testing is carried out onboard the robot, the sample can still then be stored onboard the robot (if not destroyed as part of the testing/sample preparation). This could be used for future testing, back-up testing, alternative testing, storage or archiving of historical tests, or just to be disposed of later. Or the sample could be disposed of by the robot and not stored, i.e. it could be disposed of externally to the robot, or disposed of in a disposal unit onboard the robot where once tested samples are dumped. If all samples taken in a time period are disposed in a single unit it would not be possible to determine where different samples were taken from, but this may not matter if all necessary data has been collected from the samples.

The robot of FIG. 5 is capable of cleaning as well as sample collection. Shown is cleaning means 30, which is a disinfectant spraying means, which is spraying disinfectant 32. A cleaning fluid or disinfectant supply unit 34 is shown.

Any means known in the art of cleaning or disinfecting could be mounted on such a robot. Robots could clean a location by one or more of the following: spraying or releasing a disinfectant or cleaning material, using a UV or UV-C lamp, mechanically agitating the location, or vacuuming the location.

Cleaning means could be mounted on a traverse guide is fixed in relation to the ground wheel arrangement 24, so that it will clean one line of a set cleaning width. The ground wheel arrangement 24 can then notch forward, moving the whole robot 10 forward for it to clean another line. Alternatively, a traverse guide 62 can be movable relative to the ground wheel arrangement 24 in the direction of travel, so that an area may be cleaned while the ground wheel arrangement 24 is stationary, and then the ground wheel arrangement 24 can move forward by the length of the area of cleaning so as to clean an adjacent area. A cleaning head could for example, clean a line of 20 cm width, then the ground wheel arrangement 24 notch forward by 20 cm. The robot 10 can therefore clean a strip wider than the width W of the ground wheel arrangement 24 and when an entire strip of are to be cleaned has been cleaned turn around to clean an adjacent strip. In this way, the ground wheel arrangement 24 does not run over any part of the freshly cleaned ground, the outer tracks 66 of the ground wheel arrangement 24.

The cleaning means could be height adjustable, whereby to alter level of cleaning carried out by the robot or to adapt to ground irregularities. The cleaning means could clean more than just the ground, they could clean things that need cleaning off the ground such as walls, beds, tables, toilets or anything described herein where a sample could be collected from (other than a patient themselves).

The robots and method of using such robots described herein may also have additional components, with act in tandem or as a replacement with the described deposition. For example, a hoover or deposition removal device could be added to the robot, where the material deposited e.g. a cleaning fluid or decontamination material can be hoovered or vacuumed up and removed by the robot.

The robots and method of using such robots described herein may also carry out multiple functions at the same time. For example, robots may comprise both cleaning and sample collect means.

FIG. 6 is a flow diagram showing another exemplary method of the present invention. The steps of the method described herein could be applied to all methods described herein. This is similar to the flow diagram shown in FIG. 4, however could be carried out by the robot shown in FIG. 5. The flow starts at step S600, where the robot being turned on or starting, starting movement and can act as described in S400 above.

In step S602 the robot collects at least one sample from a location. Sample collection and location can be by means as described above in step S402. However, different to as described in FIG. 4, the sample is tested onboard the robot. This can be testing as described above.

A decision can then be made at decision S606, either also onboard the robot or externally to the robot, possibly in an automated fashion or possibly actively made by a user. If the test result indicates something above a predetermined threshold level, as noted in FIG. 6, or some other positive indicator such as the presence of something (in a yes/no test), i.e. if ‘yes’, then the robot could make the decision to clean the location the sample was collected from using the cleaning means 30. If nothing is detected or determined by the test, i.e. if ‘no’, then the robot will skip the cleaning step and move onto the next step—S610. The cleaning could be carried out after multiple samples have been collected and tested, using a memory function to know which locations had samples collected and subsequently tested and found to be above a pre-determined threshold level to require cleaning.

Once the sample is collected and tested the sample can then be stored onboard the robot, or it can be disposed of as described above. Samples can be stored as described above.

As depicted in FIG. 4 also, the robot can then decide in step S610 if it is to go on to collect further samples, step S602, or end the process and .e.g. turn itself off, step S612. This and the other functions, collection, pathing, storage etc. are as described in relation to FIG. 4 in FIG. 6.

FIG. 7 is a schematic diagram of an exemplary secure communications network between an exemplary robot of the present invention robot, the edge, the cloud and a data processing device. A smart communications module 22 includes processing circuitry 80 coupled to memory circuitry 82 e.g. volatile memory (V)/non-volatile memory (NV), such as such as flash and ROM.

The memory circuitry 82 may store programs executed by the processing circuitry 80, as well as data such as user interface resources, time-series data, credentials (e.g. cryptographic keys) and/or identifiers for the remote resource (which may for convenience be referred to as the cloud 100 or the edge 102(s) (e.g. URL, IP address). The memory circuitry 80 may also comprise access to machine learning algorithms stored in libraries to provide for an artificial intelligence equipped autonomous robot 10. AI-based sampling for all the sampling/swabbing methods described herein and robots may also have AI capability to ‘hand-off’ of samples to local testing units or facilities, through automated processes.

The module 22 may also comprise communication circuitry 84 including, for example, near field communicating (NFC), Bluetooth Low Energy (BLE), WiFi, ZigBee or cellular circuitry (e.g. 3G/4G/5G/6G) for communicating with the remote resource(s)/device(s) e.g. over a wired or wireless communication link 86. For example, the module 22 may connect to remote resource(s)/device(s) within a local mesh network over BLE, which in turn may be connected to the internet via an ISP router.

The module 22 may also comprise input/output (I/O) circuitry 88 such as sensing circuitry to sense inputs (e.g. via sensors (not shown)) from the surrounding environment and/or to provide an output to a user e.g. using a buzzer or light emitting diode(s) (not shown). The module 22 may generate operational data based on the sensed inputs, whereby the operational data may be stored in memory 82. The I/O circuitry 88 may also comprise a user interface e.g. buttons (not shown) to allow the user to interact with the module 22.

The processing circuitry 80 may control various processing operations performed by the module 22 e.g. encryption of data, communication, processing of applications stored in the memory circuitry 82.

The module 22 may also comprise a display e.g. an organic light emitting diode (OLED) display (not shown) for communicating messages to a user.

The module 22 may generate operational data based on the sensed inputs. Although, the module 22 may comprise large scale processing devices, often the robot 10 will be constrained to battery power and so power may need to be managed and prioritised for movement of the robot 10 and actuation of the functions of the robot.

A relatively small scale data processing device can be present in the robots, having limited processing capabilities, which may be configured to perform only a limited set of tasks, such as generating operational data and pushing the operational data to a remote resource 100, 102 such as shown in FIG. 8.

The module 22 may, for example, comprise an embedded temperature sensor, which generates operational data based on the temperature of the surrounding environment, and may, for example be generated as a time series and fed, as best seen in FIG. 8, to a remote resource such as the cloud 100, the edge 102 such as a tablet used to control the robot 10 via communications link 86. The cloud 100 or the edge 102 may by return send instructions back to the robot 10 via a communications link 104 for the real-time adjustment of operation of the robot based on the data. In the present example, the cloud 100 and edge 102 may also communicate with each other via a communications link 108 and 110. This could be to update the instructions, send new instructions, initiate or prevent the operation of the robot. The edge 202 may be between the communication between the robot 10 and the cloud 102. The robot laser 40 and position sensor 38 may communicate with the cloud 100 and/or the edge 102 to feedback into the real-time adjustment of robot functions based on the data.

Alternatively, the module 22 may, for example, comprise an accelerometer which generates data relating to the movement of the robot 10, for example capturing distance moved, or elevation ascended/descended by the robot 10 and fed to the cloud 100 or edge 102 for analysis.

Alternatively, the module 22 may, for example, comprise a sensor which measures obstructions to the pathing of the robot. These could be people, such as medical practitioners, or other such objects which the robot senses around it during operation.

All of this data described in addition to the sample testing data can be captured and stored as part of the data generated by the robot, and linked to the sample testing data. This is described in more detail later on.

FIG. 8 schematically shows an example of the robot 10 in communication with the cloud 100, the edge 102, such as remote resource, which may be a tablet, smartphone or laptop when the present techniques are applied. The edge 102 may be a tablet controlled by a user, such as an operator located on site responsible for the upkeep of the facility or the robot itself.

In the present example, it will appreciated that the cloud 100 may comprise any suitable data processing device or embedded system which can be accessed from another platform such as a remote computer, content aggregator or cloud platform which receives data posted by the robot 10. Use of a cloud 100 means that the onboard memory 82 of the robot does not need to store everything, data e.g. machine learning libraries, cleaning or sampling instructions and operation instructions, history data can be stored in the cloud 100.

In the present example, the robot 10 is configured to connect with the cloud 100 or the edge 102 to push data thereto, whereby, for the example, the robot 10 may be provided with the connectivity data (e.g. a location identifier (e.g. an address URL)) and credential data (e.g. a cryptographic key, certificate, a site secret) of the cloud 100 or the edge 102.

In the present example, on initialisation, e.g. powering on for the first time, the robot 10 undertakes a registration process with the cloud 100 and the edge 102 and pushes identification data and is on standby to receive instructions or data in return.

It will be appreciated that the robot 10 may connect to the cloud 100 or the edge 102, e.g. via the internet, using one or more nodes/routers in a network e.g. a mesh network. The robot 10 may connect to the nodes/routers using any suitable method, for example using Bluetooth Low Energy, ZigBee, NFC, Wi-Fi.

In alternative embodiments, a user may specify to which remote resource the robot 10 should push data. For example, the user may connect the robot 10 directly to a portable device e.g. via universal serial bus (USB), and install code capable of executing on the robot 10, whereby the code may comprise connectivity data and/or credential data relating to the remote resource with which the user wants the robot to communicate. The connectivity data and/or credential data may be provided to the robot 10 using any suitable method e.g. via USB/BLE. The credential data may also comprise credential data relating to a network to which the robot 10 may be required to connect e.g. WPA2 key for pairing with nodes in a Wi-Fi network.

The remote resource 100, 102 may confirm receipt on receiving data from the robot 10, for example, by providing a summary data e.g. a hash value representative of the data to the robot 10, whereby the summary data may be signed by the remote resource 100, 102 (e.g. using a cryptographic key, such as a private key of the remote resource). The robot 10 may then verify the signature of the remote resource e.g. using a public key of the remote resource pre-provisioned on the robot 10, and may also verify the summary data. If the verification of the signature/summary data fails, the robot 10 may alert the user e.g. by activating an LED on the robot 10 in a particular sequence.

It will be appreciated that the length of time taken to the push the data from the robot 10 to the remote resource 100, 102 will depend on various factors, including the size of the data, the device bandwidth, the communication circuitry available and the associated communication protocols used to push the data.

By caching the data at the remote resource, robot 10 is not required to repeatedly push the data to the remote resource. Therefore, once the data is cached at the remote resource 100, 102, the bandwidth available for pushing more data from the robot 10 is increased.

Therefore, it will be appreciated that the robot 10 can send data dependant on its bandwidth and further dependant on a connection being available. It can send data, even if not specifically requested by the remote resource 100, 102.

A user wishing to access the data at the remote resource 100, 102 may do so subject to user privileges and subscription services using a client device 106 such as smartphone or tablet. In an illustrative example, the user may connect to the remote resource 100, 102 using a browser on the client device 106, whereby, for example, whereby clicking a link in the browser will cause the client device 106 to fetch the data from the remote resource 100, 102, which in the present example is a web-application 108.

The web-application 108 will start in the browser on client device 106 and cause the client device 106 to fetch data from the remote resource 100, 102. The web application will process the fetched data to provide a user interface to the user on the client device 106, whereby the user interface comprises the data presented in a human friendly form such as may be shown in.

In some embodiments, the client device 106 may download an application (e.g. an IoS application) from the remote resource 100, 102, which was pushed to the remote resource 100, 102 from the robot 10, whereby the application is executed on the client device 106 to control fetching and processing of data.

FIG. 9 shows an exemplary system set up. The robot 10 is also shown to be in communication with Smart Reflector 916, which as described herein is part of the robot positioning system. A robot 10 can communicate with remote resources—cloud 100 and operator 102. Robot(s) 10 can send data collected wirelessly or generated on board to these connected remote resources. Alternatively, or additionally, they can deposit samples, in onsite networked data analysis/swab testing facilities as described above. Data results can then be transmitted to edge/cloud for interpretation and analysis. The cloud system 100 allows for the generation and pushing of mission plans, generation and pushing of cleaning plans, analysis of heat maps and any other related analytics. Data links to 3rd party agencies (such as NHS England, Government, Policy Agencies, Insurance firms, de-risking companies etc) and can be part of production of risk stratification models. This is described in more detail herein.

Within the cloud network 100 there is represented inventory application programming interface (inventory API) 901, for the warehouse operation 910. Warehouse operation 910 represents inventory management—maintenance, building of robots and systems, machine learning tuning, troubleshooting and storage of robots 10, where robots 10 can be updated and have diagnostics checked or updated (possibly remotely).

Within the cloud network 100 there is represented D.R.O.N.E. API 904 which refers to the robot API (D.R.O.N.E. is a nickname for the robots described herein). This links the robot to the other APIs and overall control.

Within the cloud network 100 there is represented a dashboard 906. Provider and client computer systems (912 and 914) are also represented. The provider (the company providing and running the robot services) and the client who has purchased these robots/services can interact, through dashboard 906, to raise tickets, buy goods, book repairs, etc. For example, these front end and back end services allow ordering of stock.

Operator UIs which connect to the dashboard can have dedicated applications to enable the user to control functions of the robots (or a robot fleet), access front end/back end data, review heat maps, review or create mission plans, follow instructions for surveying reflector placements as part of the location and movement system etc.

Data collected by the robots can be formed into ‘Heatmaps’ to represent the cleanliness or hygiene levels, or other data collected, or multiple data types, in a visual map format. This can act as a visual evidence for, for example, targeting hotspots of pathogens/microbes/bacteria/viruses for remedial cleaning (e.g. disinfecting) and other cleaning management techniques. FIG. 10 is an example heat map that could be produced by the presently claimed methods, processes, systems and robots described here.

Shown in FIG. 10 is an exemplary heatmap generated of a single floor of a building. Left to right high density hatched areas (1102, 1104, 1106, 1108, 1110, 1112) are areas of the highest density of positive sample collection, e.g. levels of dirt or pathogens detected. Left to right low density hatched areas (1120, 1122, 1124) are areas of medium density of positive sample collection, e.g. levels of dirt or pathogens detected. Right to left high density hatched areas (1130, 1132, 1134, 1136, 1138) are areas of the lowest density of positive sample collection, e.g. levels of dirt or pathogens detected. Other gradient hatched areas can be seen on the map and could represent intermediate area of higher or lower density. Pictures depicted in black and white for illustrative purposes, however they could have a colour gradient e.g. a colour gradient going from red to orange to yellow to green to blue, from highest to lowest density. Labels shown are only approximate.

FIG. 11 is another example heat map that could be produced by the presently claimed methods, processes, systems and robots described here. Shown in FIG. 11 is an exemplary heatmap generated of a building with multiple floors. Left to right high density hatched areas (2102, 2104, 2106, 2108, 2110) are areas of the highest density of positive sample collection, e.g. levels of dirt or pathogens detected. Left to right low density hatched areas (2120, 2122, 2124) are areas of medium density of positive sample collection, e.g. levels of dirt or pathogens detected. Right to left high density hatched areas (2130, 2132, 2134) are areas of the lowest density of positive sample collection, e.g. levels of dirt or pathogens detected. Labels shown are only approximate.

The data related to any, multiple of, or all of the above described functions, such as movement, elevation, temperature, people or objects around the robot, can be collected and stored. This data can also be used to generate maps such as the heat maps exemplified above. More than one data type can be shown on a single map.

Other data that can be collected by the robots include light levels (for example with a lux meter, light detector), air quality (for example level of oxygen or CO₂, level of pollutant or particulates in the air, tests could be carried out onboard the robot, could be used in conjunction with air-virology testing), moisture levels (for example measuring dry air or damp), wetness or dryness of testing surfaces (for example to test floor safety), number of people or other objects around the robot (for example footfall, how often the robot had to move around people through smart sensors), or any other parameter which could be linked to a building or facilities safety, environmental condition or quality.

Robots can operate with lookup tables, which could include the following data bases for example:

Location Data, e.g.:
Pinpoint random locations
Door x, y, z, a, b, c
Floor x, y, z, a, b, c
Wall x, y, z, a, b, c
Bathroom Door x, y, z, a, b, c
Kitchen Door x, y, z, a, b, c
Canteen Door x, y, z, a, b, c
Room no x, y, z, a, b, c
Building level x, y, z, a, b, c
Building number 1, 2, 3, 4, 5 . . .

Room type data, e.g.: hospital ward, Corridor, Laboratory, Pharmacy Waiting room, Theatre, Classroom, Library, Changing room, Office.

Facility type e.g.: Hospital, GP, Dentist, School, Gym, Airport

Sampling method e.g.: Air quality, Light, Microbe, Bacteria, Virus, Dirt (Cleanliness), Moisture (dry air or damp), Wet/Dry (Floor safety).

Tests available, e.g.:
Air quality 1, 2, 3, 4
Light level (pass or fail)
Microbe 1-n
Bacteria 1-n
Virus 1-n
Cleanliness (pass or fail)

Robot Mission type, e.g.: Hygiene swab, Air quality only, Light quality only, Cleanliness only, Combined mission, Disinfect mission

Robots will also be able to record time of day and/or time of day each sample was taken or other such data point collected.

Data generated can also be analysed and presented in other formats, other than heat maps. Data points linked together, such as time and cleanliness or hygiene, or measured footfall and cleanliness or hygiene could provide powerful tools to those who need to manage locations, both on an individual location and on a site/organisation/company/regional/country/world-wide scale. AI and machine learning protocols and programs can then work together to analyse data (either onboard or externally to the robots) to enable robots to remember/recognise areas where problems typically occur (from historical sampling data e.g. based on heat map hot spots) and, based on algorithms suggest adjustments to future mission plans (for sampling and/or disinfecting) to increasing targeting in those areas and then to revert when these areas become ‘under control’. With uplink the cloud systems as described herein this can be carried out in a real-time manner, and can be carried out across a fleet of robots, not just relying on a single robot to carry out all sampling and/or cleaning functions.

Data collected can be stored in databases with functionality (entity relationship diagrams, schematics, use cases, roles, missions, etc) to enable future location (e.g. site/organisation/company/regional/country/world-wide) comparative data analysis on sampling, disinfecting, cleanliness and hygiene standards, as well as hot-spots/issues. It will also include data sharing methods for 3rd parties such as insurance companies, health organisations such as the UK's NHS, the World Health Organisation.

An exemplary method of how mission plans and heatmaps for the robots could be carried out are as follows:

Step 1

The floor plan layout is digitised, using a grid reference—x,y; marking on each map the corridor, door, floor, entrance, exit, wall, feature etc. This could be done by importing BIM (Building information models), CAD drawings or by scanning building layouts using digital scanners or manual methods.

Alternatively, it is possible that a smart reflector system and passive reflector system could be placed appropriately within a building could be used to identify object locations, entrances etc. The robots may comprise means to interact with a reflector system to be able to map and/or navigate through such an area. Alternatively, known methods of autonomous vehicle computer vision could enable real time obstacle mapping/detection.

Step 2

Once digitised, floor plans are converted into “baseline mission plans” (BMPs) using edge, corner and feature detection image analysis to create unique descriptors of current known obstacles, walls, corridors etc. This can be used to identify midpoints between obstacles etc. Once all midpoints are known, arrays of midpoints create midpoint string routes (MSRs). All MSRs for a particular zone, floor or floor plan become a robot mission plan. MSRs can be represented on maps, perhaps for a whole floor of a building or for a whole building in an interactive map. All MSRs for a particular floor, zone or area can be known as a baseline mission plan (BMP).

Step 3

On the first deployment of a robot, they will follow the BMP, sampling (e.g. taking swabs) as described herein. Samples could possibly be taken at every midpoint or possibly at other predetermined locations in the BMP, as it follows the MSR.

Samples can be tested in real time or deposited for later analysis as described herein.

Step 4—Heatmap Creation

Once all samples have been analysed and reported and fed back into the system in the appropriate format, a heat map of sample data e.g. showing hygiene, cleanliness such as bacteria or dirt levels.

For each sample type collected a “Heatmap Control Chart” (HCC), which can be maintained within an external database. Each midpoint or sample location ID can have a charge created showing sample data over time. Different sample types can be mapped onto different layers of such a chart.

Every day robots take samples following the BMP and data is recorded onto the HCC of each midpoint ID.

After the first deployment (day 1 following the BMP), all HCC data at each midpoint can be visualised to present cleanliness or hygiene levels of each location, using for example a RAG rating (Red/Amber/Green) to indicate levels. In this example, each midpoint would become a coloured dot. The size of the dot could indicate severity.

Dots can be overlaid on a map. Variation in size and/or colour of dots could indicate severity. Overlapping dots may indicate a higher severity.

For example, a small green dot could be considered a safe zone (SZ) i.e. readings from sampling are at a safe level for sample type 1 e.g. MRSA. A medium sized yellow or amber dot could be at a warning level (WL), i.e. readings from sampling are at a warming level requiring some control measures (e.g. cleaning) at those particular midpoints, for sample type 1 e.g. MRSA. A large red dot could be considered at an action level (AL) i.e. readings from sampling are at an un-safe or action needed level for sample type 1 e.g. MRSA.

On HCCs other decision roles and algorithms can be attributed to trends. For example, number of consecutive rising or falling points can indicate stability or “control” of infectious disease, bacterial, etc. Similarly, the gradient or severity of rising points.

Step 5—Autonomous Creation of Mission Plans

Once heatmaps have been created using HCCs, following first deployment, a machine leaning algorithm can adjust and optimise robot sampling frequency to target zones that need it, i.e. red/amber zones preferentially. This will become an Adjusted Mission Plan (AMP) for future swabbing. This targeting information will self-learn “problem” areas by observing frequency of R and A at each location, and simultaneously observing trends on HCCs to pre-emptively predict the likely future R and A midpoints and hotspots, for example to deploy autonomous robots to disinfect (or alternatively to produce instructions for teams of manual cleaning teams). AMPs could be adjusted hourly/daily/weekly as each HCC is updated autonomously. The first mission plan discussed above is called an initial or a baseline mission plan, because it is the the first mission plan to be generated for this robot, or for this area/site/facility/location. The adjusted mission plan could be called a follow up/follow on/subsequent/machine learnt mission plan for the autonomous robot. Follow-up mission plans may be those which take into account the data collected by a robot in a previous mission plan, this could be through machine learning and understanding from analysis of data collected or generated by the robot carrying out a previous mission plan or an initial/baseline mission plan.

Step 6

Together, all heatmaps, historical data, prediction data and RAG ratings per zone, floor, building etc. will form a real-time risk stratification tool for a particular site.

Step 7

Together, all risk-stratification models for each building, site etc. will form a comparative model across all buildings/sites deploying the robot system in a region, town, country, globally etc.

According to present techniques, autonomous robots are defined as being capable of sensing their environment and moving safely with little or no human input.

A further aspect of the invention is a computer implemented method of generating a mission plan for deployment of an autonomous robot on a route in an area, the method including:

obtaining a digital file representative of the area;

detection of features of the area, the features including obstacles and determined entry and/or exit points to and from the area;

adding location of any features in the area to the digital file, the features being represented at least in two coordinates;

determining a plurality of waypoints, each waypoint representing a point in at least two coordinates that the autonomous robot can safely navigate between the features; and

joining the plurality of waypoints into a string route, the string route being the baseline mission plan for deployment of the autonomous robot on the route in the area.

Using this aspect of the present invention enables a robot to be deployed safely through an area of testing. The robot can navigate the route once deployed, safely, due to the determination of the waypoints which take into account the representation of features in the area.

The robot of this aspect of the invention is the robot as described in the other aspects of the invention. The robot can be a cleaning and/or a sample collection robot.

Preferably, the mission plan could be an initial or a baseline mission plan, i.e. the first mission plan to be generated for this robot, or for this area/site/facility/location. Or the mission plan could be a follow up/follow on/subsequent/machine learnt mission plan, or an adjusted mission plan (AMP) as described above, for the autonomous robot. Follow-up mission plans may be those which take into account the data collected by a robot in a previous mission plan, this could be through machine learning and understanding from analysis of data collected or generated by the robot carrying out a previous mission plan or an initial/baseline mission plan.

Preferably, the robot collects or takes a sample or preferably samples whilst carrying out the mission plan or whilst navigating the route. The sample or samples can preferably be collected at waypoints or randomly from points along the string route, or the robot collects takes samples at other points along the string route, or the robot collects or takes samples at a combination of all three. The samples to be taken or collected are as described herein with relation to other aspects of the invention. The collection of samples can be carried out as described in the other aspects of the invention.

Preferably, the sample or samples can have a test or multiple tests performed on them to generate at least one data point (preferably at least one data point per sample, or multiple data points per sample), wherein said at least one data point is an indicator of hygiene or cleanliness of the location from where the sample was collected. This is as described with respect to the other aspects of the invention.

Preferably, the digital file representative of the area can be a plan view, 3D view or other type of digital file which represents an area to have a mission plan generated for it. The digital file representative of the area may already have the features of the area located on it or as part of the digital file, so the detection of features of the area step just means accessing those as part of that digital file.

Detection of features could be carried out digitally on the digital file representative of the area or carried out by the robot itself or by another robot which is capable of detecting the features of the area using software and/or equipment such as laser scanners or as otherwise described herein. This could be done manually by a human user/operator. The features to be detected of the area could include obstacles and determined entry and/or exit points to and from the area, it may be that there are no obstacles or that there is only a single entry/exit point or route into/out of an area. The detection of features would take this into account when detecting the features and this would be accounted for when determining the plurality of waypoints for the route in the area. Detection of features could be carried out by performing edge and corner feature analysis or any other known detection technique known in the art.

Determining a plurality of waypoints, each waypoint representing a point in at least two coordinates that the autonomous robot can safely navigate between the features, takes into account the location of any features in the area. Because the features being represented are represented in at least in two coordinates, this allows the mapping or creation of waypoints which account for these features.

Once samples are gathered and have been analysed, reported and feedback, the indication of cleanliness or hygiene, for example location of or level of pathogens or location of or level of dirt or level of air quality can be added in at least two coordinates to the digital file.

Where the location also includes the indication of cleanliness or hygiene (e.g. the level of or concentration of pathogen and type of pathogen), the location may be represented as a heat map.

In embodiments, the baseline mission plan for deployment of the autonomous robot on the route in the area may be adjusted based on historical data records or previous mission plans taken from data represented as the heat map. A machine learning algorithm may provide predictions based on the data and the baseline mission plan for deployment of the autonomous robot on the route in the area may be further adjusted and pre-emptively predicted based on most probable future pathogen location and concentration.

A further aspect of the invention is a method of deploying an autonomous robot for the monitoring of hygiene or cleanliness, the method comprising:

generating a mission plan for deployment of the autonomous robot on a route in an area, the method including:

obtaining a digital file representative of the area;

detection of features of the area, the features including obstacles and determined entry and/or exit points to and from the area;

adding location of any features in the area to the digital file, the features being represented at least in two coordinates;

determining a plurality of waypoints, each waypoint representing a point in at least two coordinates that the autonomous robot can safely navigate between the features; and

joining the plurality of waypoints into a string route, the string route being the baseline mission plan for deployment of the autonomous robot on the route in the area; and

the method further comprising deploying the robot on the string route, the robot collecting at least one sample from a location on the string route; performing at least one test on the at least one sample to generate at least one data point, wherein said at least one data point is an indicator of hygiene or cleanliness of the location from where the sample was collected; and recording the data point in a data file.

It will be clear to one skilled in the art that many improvements and modifications can be made to the foregoing exemplary embodiments without departing from the scope of the present techniques.

1: A method of monitoring hygiene or cleanliness, the method comprising:
a. a robot collecting at least one sample from a location;
b. performing at least one test on the at least one sample to generate at least one data point, wherein said at least one data point is an indicator of hygiene or cleanliness of the location from where the sample was collected; and
c. recording the data point in a data file.

2: The method of claim 1, wherein the robot is autonomous.

3: The method of claim 1, wherein the method comprises a robot collecting multiple samples from multiple locations; and the method comprises performing the at least one test on each sample collected to generate multiple data points as multiple indicators of hygiene or cleanliness of the multiple locations from which samples were collected.

4: The method of claim 1, wherein the robot stores the sample or samples on board and then transports the sample or samples to a testing station, facility or location or means for the samples to be removed from the robot and step b. to be carried out at said location externally to the robot, or wherein step b. is performed on-board the robot.

5: The method of claim 1, wherein the robot moves autonomously between locations on a pre-determined route, path, mission plan or map.

6: The method of claim 1, wherein the location of the sample location is also recorded by the robot and added to the data file, and/or wherein the time the sample was collected is also recorded by the robot and added to the data file, wherein the test result is linked to the location of the sample and/or the time the sample was collected in the data file, preferably wherein the location of samples is known from the pre-determined route, path or map.

7: The method of claim 6, wherein the method further comprises generating a heat map of data points using the location data, preferably wherein said heat map of data points is an indicator of wider-area cleanliness or hygiene of a building, facility or single site, or indicates areas of a wider area which may need cleaning.

8: The method of claim 1, wherein the method further comprises:
d. cleaning the location from where the sample was collected, if the test result indicated that the level of hygiene or cleanliness of the sample was below a predetermined threshold value;
optionally wherein the robot cleans the location from where the sample was collected; or
optionally wherein the robot sends an indicator or a signal to another robot or a person to carry out the cleaning.

9: The method of claim 1, wherein the location or locations from which samples are collected are predetermined locations on a route, path or map to be followed by the autonomous robot, or wherein the location or locations from which samples are collected are a random or not pre-determined location or series of locations within a wider known set area.

10: The method of claim 1, wherein the robot is capable of recording other data, such as recording human footfall around the robot as it operates, and recording such data as part of the data file.

11: The method of claim 1, wherein the sample is marked by the robot after collection.

12: The method of claim 1, wherein the location is selected from the following: a floor, a wall, a roof, a bed, a door, a handle, a toilet, a sink, a bathroom, a shower, a bath, a medical item, bin, waste disposal unit, or a support such as a leg of one or more of these named locations, shoes, clothes or possessions of a patient, or a patient.

13: The method of claim 1, wherein the indicator of hygiene or cleanliness is a test of one or more of the following: level of dirt or debris, level of disease, level of virus, level of bacteria, level of microorganism, level of fungi, level of pathogen, biological material deposited, biological material present, level of waste, level of contaminants or level of sterility, air quality.

14: The method of claim 1, wherein more than one robot is collecting samples from more than one location at any one time.

15: The method of claim 1, wherein said location is a location within a medical facility, hospital, doctors, clinic, field hospital, dentist, mobile medical unit or facility, testing facility, blood donation facility, a care home or a nursing or other such palliative-type care home, rehabilitation facility, outpatient clinic, diagnostic laboratory, ambulance, medical vehicle, non-medical facility within a medical facility such as a coffee shop, or other such medical related building.

16: An autonomous robot comprising:
a. means to collect a sample from a location;
b. means to test the sample for an indicator of hygiene or cleanliness of the location from where said sample was collected and/or means to clean a testing location; and
c. means to navigate the robot.

17-23. (canceled)

24: A computer implemented method of generating a mission plan for deployment of an autonomous robot on a route in an area, the method including:
obtaining a digital file representative of the area;
detection of features of the area, the features including obstacles and determined entry and/or exit points to and from the area;
adding location of any features in the area to the digital file, the features being represented at least in two coordinates;
determining a plurality of waypoints, each waypoint representing a point in at least two coordinates that the autonomous robot can safely navigate between the features; and
joining the plurality of waypoints into a string route, the string route being the baseline mission plan for deployment of the autonomous robot on the route in the area.

25. (canceled)
